(19) United States
(12) Patent Application Publication
(10) Pub. No.: US 2012/0095932 A1
(43) Pub. Date: Apr. 19, 2012

(54) SYSTEM AND METHOD FOR DETERMINING CASE INDEX

(76) Inventor: Sai Panyam, Sunnyvale, CA (US)

(21) Appl. No.: 13/275,626

(22) Filed: Oct. 18, 2011

Related U.S. Application Data
(60) Provisional application No. 61/394,325, filed on Oct. 18, 2010.

(51) Int. Cl. G06Q 10/00

(52) U.S. Cl. 705/319

(57) ABSTRACT

A system and method of determining a composite automated site engagement (CASE) index for a website are provided, including tracking user activities at the website, and if a weighted value associated with a user activity has changed based on the tracking, calculating a market value for the user activity, calculating a divisor value for a new CASE index, calculating the new CASE index based upon the market value and the divisor, and updating a database to reflect the new CASE index.

### CROSS REFERENCE TO RELATED APPLICATIONS

The present application claims priority to U.S. Provisional Patent Application Ser. No. 61/394,325, filed Oct. 18, 2010, the entire contents of which are specifically incorporated by reference herein.

### TECHNICAL FIELD

This invention relates generally to website statistics. More particularly, this invention relates to methods and systems of calculating meaningful statistics of a social networking website through analysis of user interaction.

### BACKGROUND OF THE INVENTION

Generally, website popularity is a notion of a portion of an intrinsic value of a website in terms of overall traffic through the website. However, different types of websites exist, and simple traffic measurements may not provide meaningful analytical terms by which to accurately measure a website's popularity. For example, some websites offer membership to a plurality of clients. It follows then, that an additional measurement of website popularity May be a total number of new or unique member registrations. Furthermore, some websites offer sales of products, which would provide a measurement of total sales being facilitated through the website as a possible measurement of popularity.

However, additional websites may include services related to media sharing, personal publications/blogs, social networking, and other services. As such, it should be understood that the measurements explained above are only partially representative of popularity as many other facets of the use of a website may in fact offer better perspective into overall popularity, and therefore, intrinsic value of a website.

Accordingly, there is a need in the art for an improved system and method for calculating meaningful statistics of a social networking website through analysis of user interaction.

### SUMMARY

The above described and other problems and disadvantages of the prior art are overcome and alleviated by the present system and method of determining a composite automated site engagement (CASE) index for a website. In exemplary embodiments, such system and method include tracking user activities at the website and if a weighted value associated with a user activity has changed based on the tracking, calculating a market value for the user activity, calculating a divisor value for a new CASE index, calculating the new CASE index based upon the market value and the divisor, and updating a database to reflect the new CASE index.

Exemplary embodiments also include use of a publication portion that configured to publish the CASE index, an administration portion that is in communication with the publication portion and a subscription portion in communication with the administration portion. The administrative portion is configured to perform a method, including tracking user activities at the website and if a weighted value associated with a user activity has changed based on the tracking, calculating a market value for the user activity, calculating a divisor value for a new CASE index, calculating the new. CASE index based upon the market value and the divisor, updating a database to reflect the new CASE index, and transmitting the new CASE index to the subscription portion.

The above discussed and other features and advantages of the present invention will be appreciated and understood by those skilled in the art from the following detailed description and drawings.

### BRIEF DESCRIPTION OF THE DRAWINGS

Referring to the exemplary drawings wherein like elements are numbered alike in the several FIGS.:

FIG. 1 illustrates a system, according to an example embodiment;

FIG. 2 illustrates a publishing portion of a system, according to an example embodiment;

FIG. 3 illustrates an administrative portion of a system, according to an example embodiment;

FIG. 4 illustrates a subscription portion of a system, according to an example embodiment;

FIG. 5 illustrates a component diagram of a system, according to an example embodiment;

FIG. 6 illustrates a method, according to an example embodiment;

FIG. 7 illustrates a method, according to an example embodiment;

FIG. 8 illustrates a method, according to an example embodiment;

FIG. 9 illustrates a network, according to an example embodiment;

FIG. 10 illustrates a computer apparatus, according to an example embodiment; and

FIG. 11 illustrates a computer program product, according to an example embodiment.

### DETAILED DESCRIPTION

Detailed illustrative embodiments are disclosed herein. However, specific functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be further understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will also be understood that the terms “photo,” “photograph,” “image,” or any variation thereof may be interchangeable. Thus, any form of graphical image may be applicable to example embodiments.

It will also be understood that the terms “audio,” “audio tracks,” “music,” “music tracks,” or any variation thereof may be interchangeable. Thus any form of audio may be applicable to example embodiments.

It will also be understood that the terms “media,” “multi-media,” “ video,” or any variation thereof may be interchangeable. Thus any form of rich media may be applicable to example embodiments.

It will also be understood that the terms “statistics,” “measurements,” “analytics,” “calculations,” or other similar terms may be used to describe example forms of the associated definitions as understood by one of ordinary skill in the art, although other similar acts/functions may be applicable depending upon any particular form of an example embodiment. For example, a statistical calculation may include analytical calculations, and vice versa. Furthermore, measurements may include calculations upon, during, subsequent, or in addition to measurements or any act of retrieving data.

It should also be understood that other terms used herein may be applicable based upon any associated definition as understood by one of ordinary skill in the art, although other meanings may be applicable depending upon the particular context in which terms are used.

Therefore, the terminology used herein is for the purpose of describing particular embodiments only and is not intended to be limiting of example embodiments. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Further to the brief description provided above and associated textual detail of each of the figures, the following description provides additional details of example embodiments of the present invention.

As described herein, example embodiments of the present invention may include methods and systems of calculating meaningful statistics of a social networking or other form of website through analysis of user interaction.

As described herein-before, a plurality of meaningful measurements of particular websites may provide useful tools by which to gain insight into a website's popularity. However, as many possible measurements exist, it may be prudent to automatically aggregate measurements in a manner by which a composite value representative of the plurality of measurements is produced. For example, if a plurality of different possible user-interactions are available on any given website, a composite automated site engagement (CASE) index may be useful.

The CASE index, as used herein, describes a weighted index, or for example, a market capitalized base weighted index. The CASE index is a robust, resilient, and reliable metric which is extensible to a plurality of different possible user-interactions with a website. The CASE index establishes behavioral economic, Mathematic, and social networking facets to measure a user's engagement with a website. The extensibility of the CASE index is facilitated through a solid mathematical foundation described in detail herein-below, which includes the aspects described above.

Technical benefits include a single automatically generated metric by which to glean insight into an actual popularity or usefulness of a website. Other benefits include display of a user's statistics to facilitate more user interaction in a competitive manner, ability for a particular user to establish a measurement of their presence or footprint based on their engagement with the website, providing a monetization channel or increase in possible revenue based on presentation of the index to advertisers and/or sponsors, increasing website usage through display of individual user's statistics where users are more apt to compare statistics among other users/friends/etc, discovery of new friends or possible friends based on particular users' popularity, and other benefits.

Hereinafter, example embodiments of the present invention are described in detail.

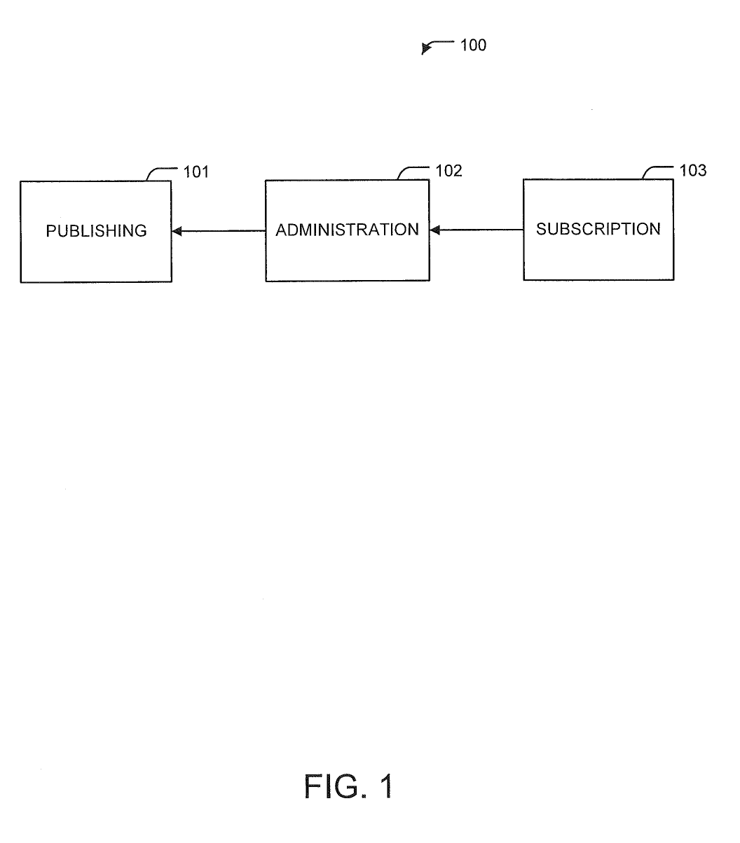

Turning to FIG. 1, a system of calculating statistics of a website is illustrated. As shown, the system 100 may include a publishing portion 101. The publishing portion 101 may be a portion of the system 100 configured to publish CASE index values. The system 100 further includes an administration portion 102 in communication with the publishing portion 101. The administration portion 102 is a portion of the system 100 configured to control aspects of CASE index calculation and storage. The system 100 further includes subscription portion 103 in communication with the administration portion 102. The subscription portion 103 may be a portion of the system 100 configured to control and store information related to CASE index subscribers.

Although illustrated and described above as separate portions or entities, it should be understood that any or all of the portions 101-103 of the system 100 may be equally designed in any suitable combination or form according to any desired implementation.

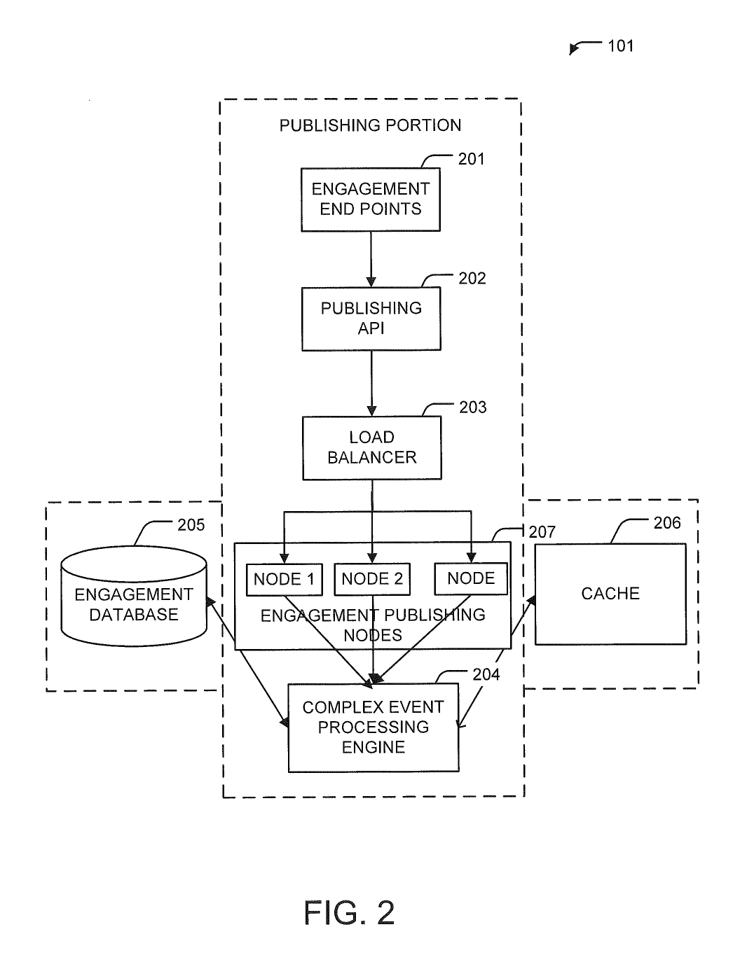

Turning now to FIGS. 2-4, a more detailed description of the portions 101-103 is provided.

As illustrated in FIG. 2, the publishing portion 101 may include engagement endpoints 201. The engagement end points may include activities or other end points related to the CASE index of a particular, website. The portion 101 may further include a publishing application programming interface (API) 202 in communication with the engagement endpoints 201. The publishing API 202 may be any suitable programming interface configured and/or disposed to retrieve information related to the CASE index of a particular website. The portion 101 may further include load balancer 203 in communication with the publishing API 203. The load balancer 203 may be any load balancing system/process configured to balance communication between the publishing API 202 and a complex event processing (CEP) engine 204. The CEP 204 may be any suitable complex event processor or process by which meaningful events can be distributed to any or all of an engagement database 205, a cache 206, and a plurality of engagement publishing nodes 207. The engagement database 205 may be any suitable database configured to store engagement values and CASE indices for any website. The nodes 207 may be any suitable nodes, including nodes configured for publishing engagement values or CASE indices for any website.

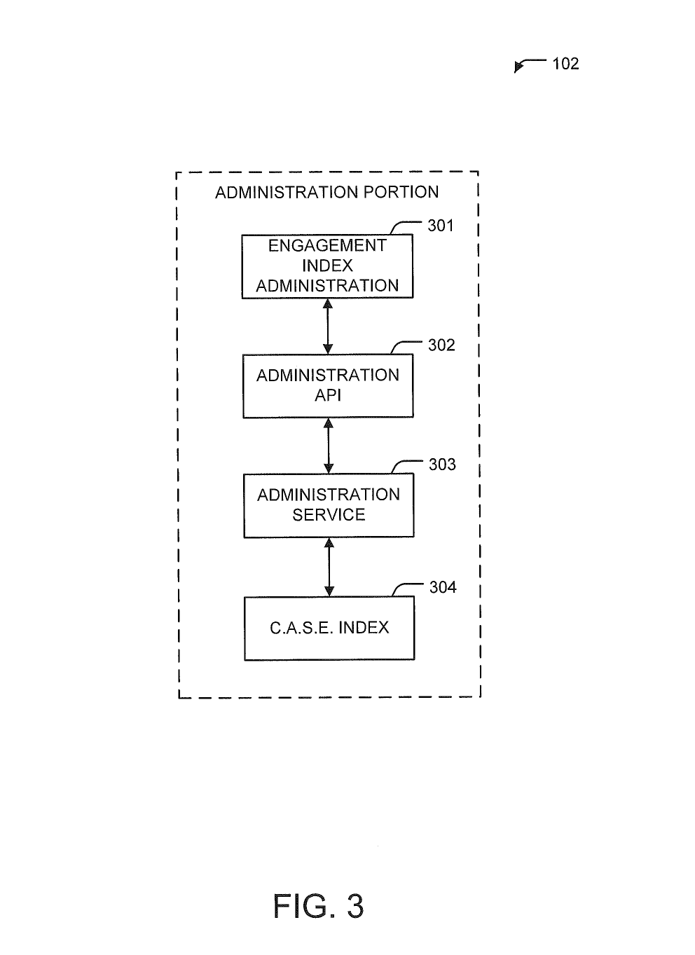

Turning to FIG. 3, the administration portion 102 of the system 100 is illustrated in more detail.

As illustrated, the administration portion 102 includes engagement index administration block 301. The engagement index administration block 301 may be a user interface configured to allow administrative control of the administration portion 102. The portion 102 further includes administration API 302 in communication with the user interface block 301. The administration API 302 may be any suitable programming interface configured to allow administrative control of calculations related to a CASE index for a website. The portion 102 further includes administration service 303 in communication with the administration API 302. The administration service 303 may be a service configured to facilitate communication between a CASE index calculation portion 304 and an engagement database (not shown).

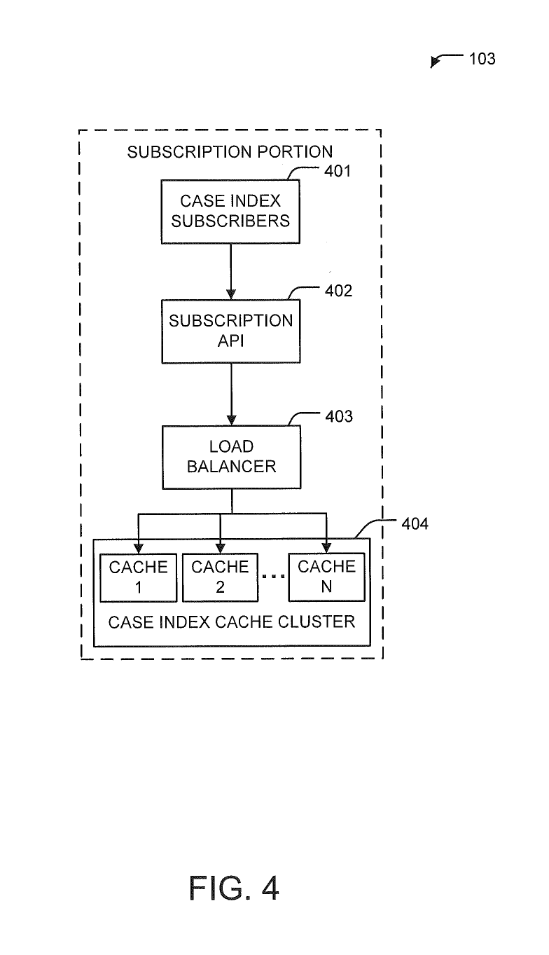

Turning to FIG. 4, the subscription portion 103 of the system 100 is illustrated in more detail.

As illustrated, the subscription portion 103 includes CASE index subscribers 401. The subscribers 401 may be any subscribers providing information for calculation of a CASE index for a website. The portion 103 further includes a subscription API 402 in communication with the subscribers 401. The API 402 may be any suitable programming interface configured to facilitate the relay of information from the subscribers 401 to a load balancer 403. The load balancer 403 may balance communication between the API 402 and a CASE index cache cluster 404, which includes a cluster of a plurality of available cache. The CASE index cache cluster 404 may be disposed as the cache 206 illustrated in FIG. 2.

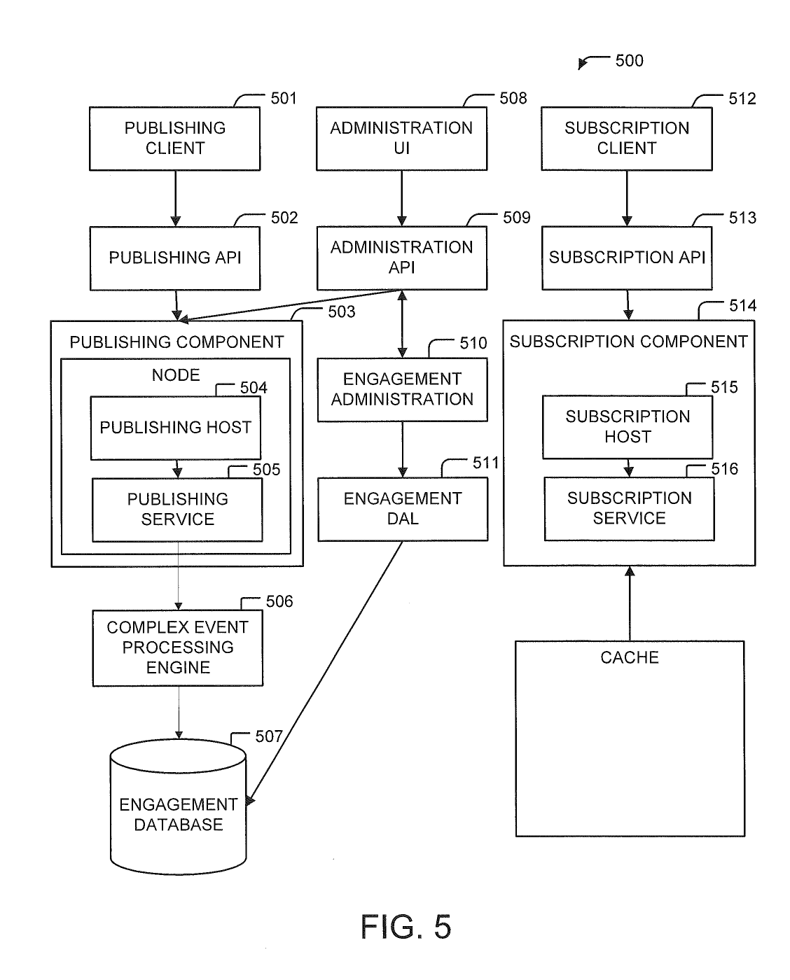

Turning now to FIG. 5, a component diagram 500 of the system 100 is illustrated in detail.

As illustrated, the components 500 include a publishing client 501. The publishing client 501 may communicate CASE index information to a publishing API 502, which may further process and communicate this information to a publishing component 503. The publishing component 503 may include one or more nodes (e.g., see FIG. 2) including a publishing host 504 and a publishing service 505. The publishing component 503 may facilitate or publish information to CEP 506 which in turn processes meaningful events to the engagement database 507.

The components 500 further include administration user interface 508 in communication with administration API 509. The administration API 509 may communicate CASE index information to the publishing component 503 for publishing/processing, and to engagement administration component 510. The engagement administration component 510 may transfer information through an engagement data access layer component (DAL) or data application block 511 to subscription service 516.

The subscription service 516 may be in communication with a subscription host 515, and may be included within cache of a subscription component 514. Furthermore, the subscription component may receive information related to subscription client 512 through subscription API 513.

As described above, example embodiments include systems for calculating meaningful statistics of a social networking or other form of website. Hereinafter, methods of calculating meaningful statistics of a social networking or other form of website are described in detail.

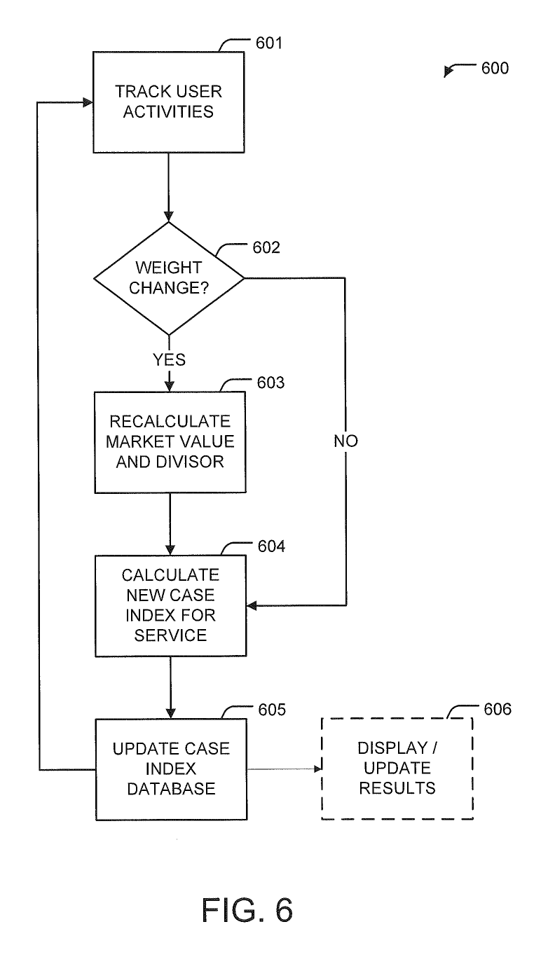

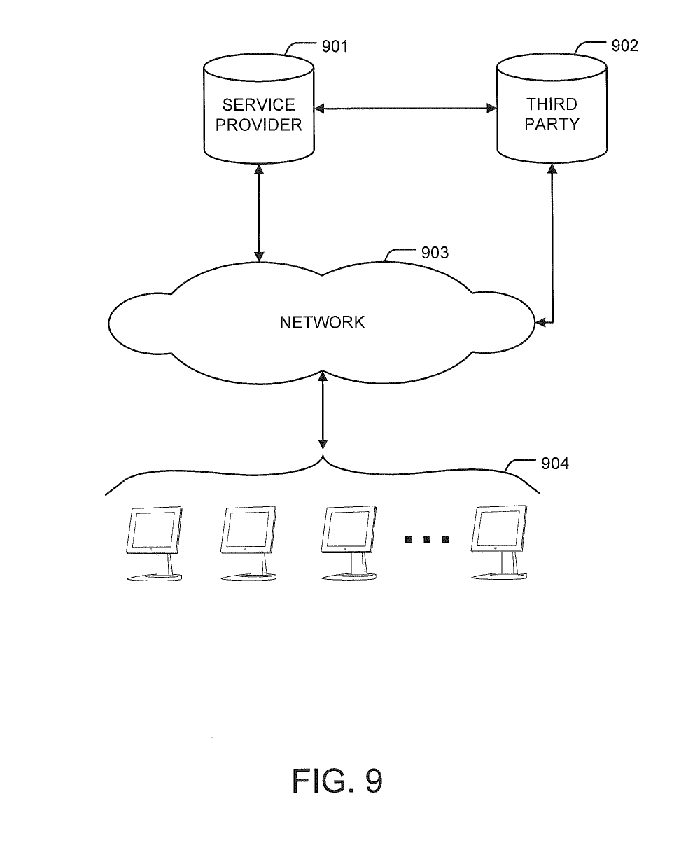

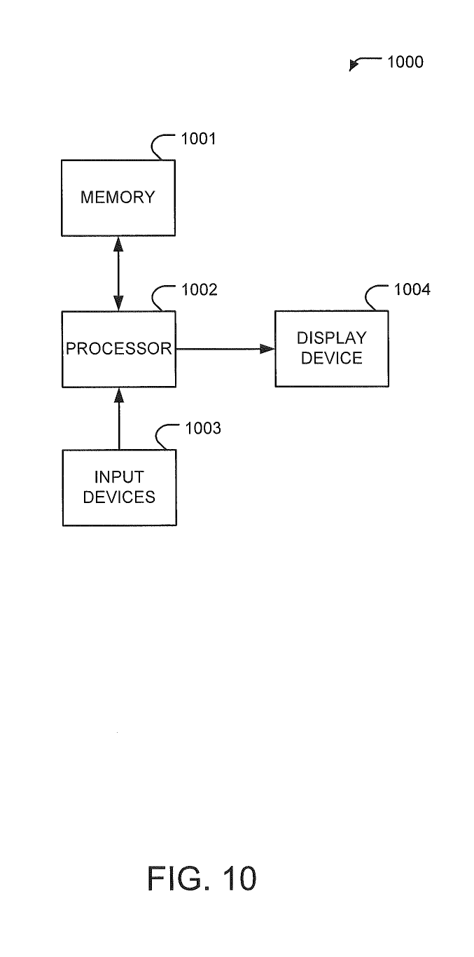

Turning to FIG. 6, a method 600 is illustrated. The method 600 includes tracking user activities at block 601. For example, the user activities may include interaction(s) with a website for which a CASE index is desired. The user activities may include interaction with the website through a browser or other application installed or executing on a user computer apparatus (see FIG. 10). The computer apparatus may be in communication with the website over a network (e.g., the Internet) or other form of communication medium (see FIG. 9). The user activities may include any activity by which meaningful interaction may be measured.

Examples of user activities may include clicking through an advertisement, adding a new friend of a social network, expanding a social network, posting real user activities (e.g., status updates, events, etc), uploading and/or sharing multimedia, sharing photos, sharing video, sharing music, or any other suitable activity. Furthermore, user activities may include clicking, accessing, or sharing content already uploaded to the website. For example, a user may access video, music, or any other suitable material posted by a friend or member of a social network, and thus these activities may be tracked. Additionally, a user may click a shared web-link, URL, or other dynamic content previously posted, and thus these activities may also be tracked.

Moreover, any other useful or meaningful user activity including new user registration, increasing/decreasing number of friends, web sales, photo deletion, content removal, et cetera may also be tracked. It is also noted that the activities described above are only examples of possible activities to be tracked, and should not be construed as limiting.

Turning back to FIG. 6, the method 600 further includes determining if there is a weight change at block 602 based on the tracked user activities. For example, the weight may include a metric valued upon a type of user interaction or activity as described above. The weights may be based upon a fixed value or a dynamic value which changes depending upon changes in activities (e.g., posting video may be more weighted over time, or web-link postings may weigh less over time). Furthermore, the weights may be stored as fixed values or as a range of values in a table or other storage base. Additionally, weights may be calculated on the fly to take into consideration fluctuations in user activity.

The method 600 may further include calculating or recalculating a market value and divisor at block 603 based upon the weight change. The market value is a value dependent upon the type of activity (e.g., engagement) and the weight of the engagement. The divisor is based upon a previous divisor (constant may be substituted for initial value) and a previous CASE index value. For example, Equation 1 below depicts an example calculation which may be used to determine the divisor:

$${d}_{new} = {d}_{old} + \frac{{( {\sum }_{i = 1}^{n} {N}_{i} \cdot {W}_{i} )}_{new} - {( {\sum }_{i = 1}^{n} {N}_{i} \cdot {W}_{i} )}_{old}}{{Index}_{old}} \qquad Equation 1$$

According to Equation 1, is the d_{new} divisor, d_{old} is the previous divisor, Nᵢ is a number of shares (e.g., market value), Wᵢ is the weight, and Index_{old} is the previous CASE index value.

The method 600 further includes calculating the new CASE index value at block 604 with the new market value and divisor. For example, Equation 2 below depicts an example calculation which may be used to determine the new CASE index:

$${Index}_{new} = \frac{{( {\sum }_{i = 1}^{n} {N}_{i} \cdot {W}_{i} )}_{new}}{{d}_{new}} \qquad Equation 2$$

The method 600 further includes updating the CASE index database at block 605 with the new CASE index value. Thereafter, the results may be output or displayed, and/or the method may continue to track user activities at block 60, thereby providing automated CASE index calculations for a website.

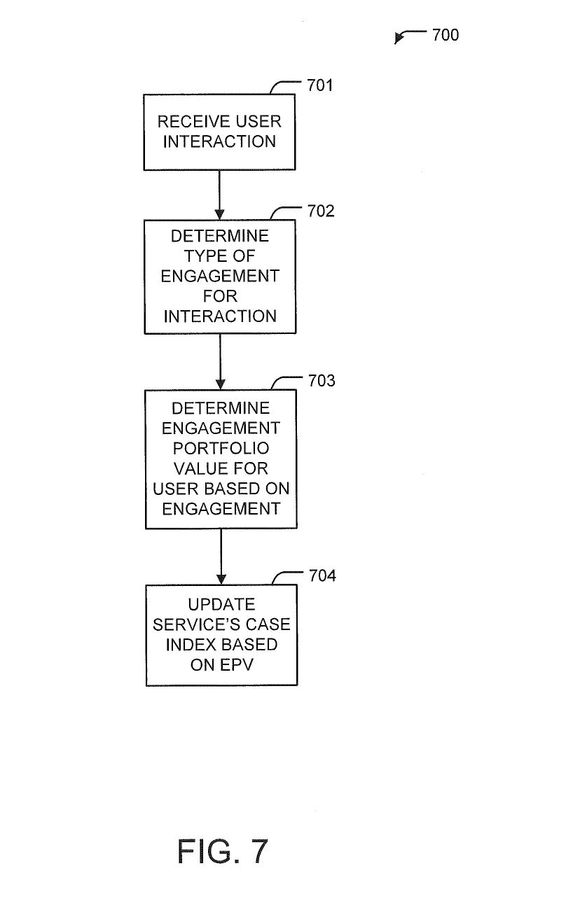

Turning now to FIG. 7, an additional method is illustrated. As illustrated, the method 700 includes receiving user interaction at block 701. The user interaction may include any of the engagements and/or activities described above. Thus, exhaustive description is omitted herein for the sake of brevity.

The method 700 may further include determining a type of engagement for the interaction at block 702. For example, a type of engagement may be determined through processing of available engagement types/weights/values associated for a particular form of interaction. Accordingly, if a user interacts with a website in a particular manner, that interaction may be associated with an engagement weight thereby providing information to calculate a CASE index.

The method 700 further includes determining an engagement portfolio value (EPV) for the user at block 703 based upon the type of engagement. The engagement portfolio value may be a value representing a sum of all of the user's engagements taking into consideration associated weights. For example, Equation 3 below depicts an example calculation which may be used to determine an engagement portfolio value:

EPV=Σᵢ₌₁ⁿ Eᵢ*Wᵢ Equation 3:

The method 700 further includes updating a website's or service's CASE index at block 704 based upon the user's EPV. Furthermore, or alternatively, the EPV may be associated with the particular user interacting with the website and/or may be displayed for the user such that further user interaction may occur in an attempt to increase his/her EPV. In this manner, a website may attract additional interactions which may lead to an increase in popularity, revenues, and other additional benefits.

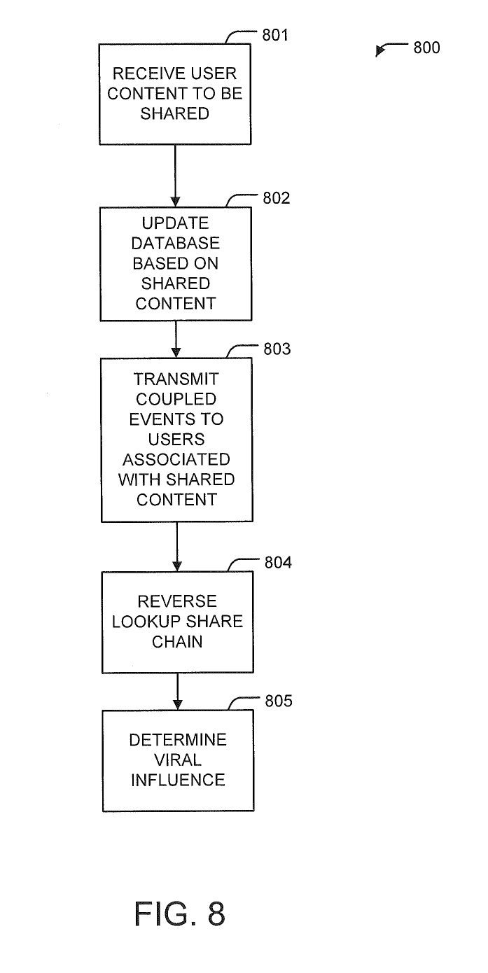

Turning to FIG. 8, an additional method is illustrated. As illustrated, the method 800 may aid in determining a particular user's popularity based upon a viral influence calculation. This viral influence calculation may aid in determining additional factors in CASE index calculation, may be used/posted by a user to display his/her particular popularity, may be used in combination with EPV's of users to determine valuable users, or in other suitable uses.

Turning back to FIG. 8, the method includes receiving user content to be shared on a website at block 801. The user content may be textual (i.e., status posts, notes, blogs), video, music, audio, media, or any other content. Upon receiving the content, the method 800 includes updating a user's federated database at block 802. A user's federated database may be a meta-data-based database fluidly integrated into an overall database representing user interactions, user content, and other information of a website.

Upon, or subsequently to, the database update, the method 800 includes transmitting coupled events to users associated with the shared content at block 803. The coupled events may be a form of event information to be stored in each user's database. The coupling of the events provides for a relatively easy back-tracking to an original source of the shared content (i.e., original user sharing the content).

The method 800 further includes reversely looking up a share train of the shared content at block 804 through the website's overall database. The reverse lookup may include a traversal through coupled events to determine an overall number of repeat shares and/or content accesses of the originally posted content, which may be used to calculate viral influence of the content at block 805. The viral influence may be displayed for a user, be weighted or added to engagement weights for a user to aid in future CASE index calculations, or in any suitable calculation/metric. Further, although described as being determined for “originally shared content,” it should be understood that the reverse lookup may be performed for each user on the chain, to determine each particular user's viral influence upon the shared content. For example, of a first group of users to which the original content was shared with, a determination of viral influence for each user of that group of users may be determined. Furthermore, of a second group of users to which any user of the first group of users shared the content with, a determination of viral influence for each user of the second group may be determined. This may be extensible to the last “node” of any portion of the original share chain, thereby providing a measure of viral influence of every user, or even a portion of users, on the share chain.

Accordingly, as described above, example embodiments of the present invention may include methods and systems of calculating a CASE index, or any meaningful statistic, for any webpage. The CASE index may be applied to determine a website's popularity, usefulness, or a portion of its intrinsic value to a web community, thereby providing channels for increased monetization of the website through 3^{rd} party sponsors, advertisers, or other forms of revenue.

An example website and networked system is provided in FIG. 9. As illustrated, a website/service provider 901 may provide a website hosting service over network 903. The network, and therefore the website, may be accessed by a plurality of users 904. Further, a third party 902 may be in communication with the service provider and/or network, and may therefore be provided CASE index information from the provider 901. In this manner, the third party 902 may increase/decrease sponsorship, advertising, payments, et cetera based upon the provider's calculated popularity within a web community. The community may include more or less users than those depicted, and may be extensible across more networks or across the entire Internet, depending upon and desired implementation. For example, a small web community with privileged access to the provider 901 may be assembled, for example, as a private social network. Furthermore, a public social network may be assembled. Thus, example embodiments should not be limited to only a website on the Internet, but rather any organizational model which may use a CASE index to calculate its popularity, influence, value, or other characteristic back to a web community, internally, or any third party.

It is further noted that embodiments of the invention may be embodied in the form of computer-implemented processes and apparatuses for practicing those processes. Therefore, according to an exemplary embodiment, the methodologies described hereinbefore may be implemented by a computer system or apparatus. For example, FIG. 10 illustrates a computer apparatus, according to an exemplary embodiment. Therefore, portions or the entirety of the methodologies described herein may be executed as instructions in a processor 1002 of the computer system 1000. The computer system 1000 includes memory 1001 for storage of instructions and information, input device(s) 1003 for computer communication, and display device 1004. Thus, the present invention may be implemented, in software, for example, as any suitable computer program on a computer system somewhat similar to computer system 1000. For example, a program in accordance with the present invention may be a computer program product causing a computer to execute the example methods described herein.

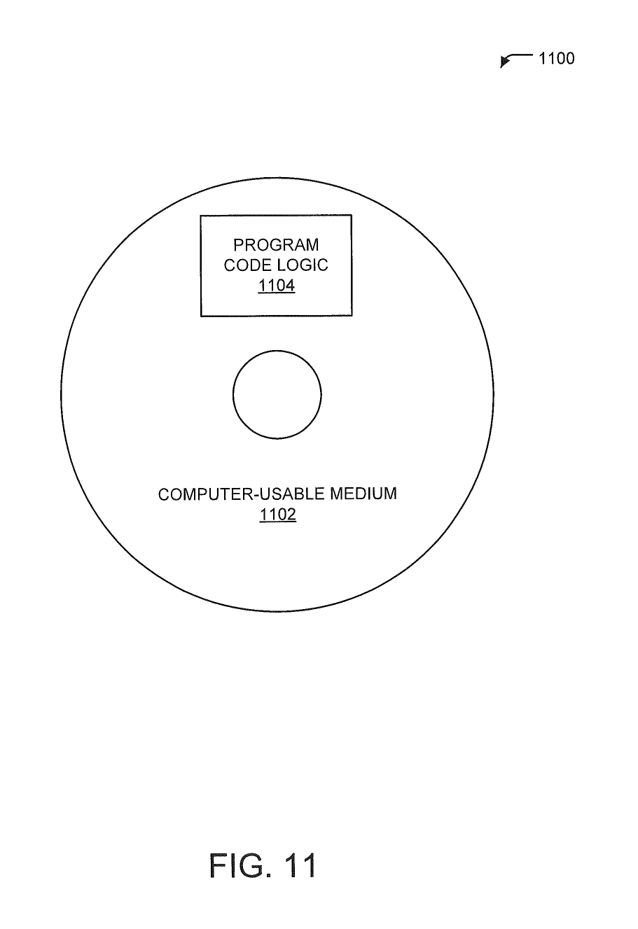

Therefore, embodiments can be embodied in the form of computer-implemented processes and apparatuses for practicing those processes on a computer program product. Embodiments include the computer program product 1100 as depicted in FIG. 11 on a computer usable medium 1102 with computer program code logic 1104 containing instructions embodied in tangible media as an article of manufacture. Exemplary articles of manufacture for computer usable medium 1102 may include floppy diskettes, CD-ROMs, hard drives, universal serial bus (USB) flash drives, or any other computer-readable storage medium, wherein, when the computer program code logic 1104 is loaded into and executed by a computer, the computer becomes an apparatus for practicing the invention. Embodiments include computer program code logic 1104, for example, whether stored in a storage medium, loaded into and/or executed by a computer, or transmitted over some transmission medium, such as over electrical wiring or cabling, through fiber optics, or via electromagnetic radiation, wherein, when the computer program code logic 1104 is loaded into and executed by a computer, the computer becomes an apparatus for practicing the invention. When implemented on a general-purpose microprocessor, the computer program code logic 1104 segments configure the microprocessor to create specific logic circuits.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It should be emphasized that the above-described example embodiments of the present invention, including the best mode, and any detailed discussion of particular examples, are merely possible examples of implementations of example embodiments, and are set forth for a clear understanding of the principles of the invention. Many variations and modifications may be made to the above-described embodiment(s) of the invention without departing from the spirit and scope of the invention. All such modifications and variations are intended to be included herein within the scope of this disclosure and the present invention and protected by the following claims.

What is claimed is:

1. A computer-implemented method of determining a composite automated site engagement (CASE) index for a website, comprising:
tracking user activities at the website;
if a weighted value associated with a user activity has changed based on the tracking,
calculating a market value for the user activity,
calculating a divisor value for a new CASE index,
calculating the new CASE index based upon the market value and the divisor, and
updating a database to reflect the new CASE index.

2. A computer-implemented method in accordance with claim 1, wherein said CASE index is a market capitalized base weighted index.

3. A computer-implemented method in accordance with claim 1, wherein user activities include one or more of clicking through an advertisement, adding a new friend of a social network, expanding a social network, posting real user activities, uploading multimedia, sharing multimedia, clicking, accessing, or sharing content already uploaded to the website, clicking a shared web-link, URL, or other dynamic content previously posted, new user registration, increasing/decreasing number of friends, web sales, photo deletion, and content removal.

4. A computer-implemented method in accordance with claim 1, wherein the weight of said weighted value is configured to change over time or in response with regard to user activity.

5. A computer-implemented method in accordance with claim 4, wherein said weight is computed on the fly.

6. A computer-implemented method in accordance with claim 1, wherein the market value is dependent on the type of activity and the weight of the engagement.

7. A computer-implemented method in accordance with claim 1, wherein the divisor is dependent upon a previous divisor and a previous CASE index value.

8. A computer-implemented method in accordance with claim 7, wherein said divisor is determined by
$${d}_{new} = {d}_{old} + \frac{{( {\sum }_{i = 1}^{n} {N}_{i} \cdot {W}_{i} )}_{new} - {( {\sum }_{i = 1}^{n} {N}_{i} \cdot {W}_{i} )}_{old}}{{Index}_{old}} ,$$
wherein d_{new} is the new divisor, d_{old} is the previous divisor, Nᵢ is a number of shares (e.g., market value), Wᵢ is the weight, and Index_{old} is the previous CASE index value.

9. A computer-implemented method in accordance with claim 1, wherein said new CASE index is calculated according to
$${Index}_{new} = \frac{{( {\sum }_{i = 1}^{n} {N}_{i} \cdot {W}_{i} )}_{new}}{{d}_{new}} .$$

10. A computer-implemented method in accordance with claim 1, further comprising determining a type of user activity according to user interaction with a website, wherein said type of user activity is determined through processing of available engagement types, weights and values associated with a particular form of interaction.

11. A computer-implemented method in accordance with claim 10, further comprising determining an engagement portfolio value (EPV) for a user based upon the type of engagement detected, wherein said EPV is a value representing a sum of all of the user's engagements taking into consideration associated weights.

12. A computer-implemented method in accordance with claim 11, wherein said EPV is calculated according to EPV=Σᵢ₌₁ⁿ Eᵢ*Wᵢ.

13. A computer-implemented method in accordance with claim 11, further comprising updating said CASE index based upon a user's EPV.

14. A computer-implemented method in accordance with claim 13, further comprising associating a particular user's EPV with a website, such that further interaction of said particular user with the website will increase the particular user's EPV.

15. A system for determining a composite automated site engagement (CASE) index for a website, comprising:
a publication portion configured to publish the CASE index;
an administration portion in communication with the publication portion; and
a subscription portion in communication with the administration portion;
wherein the administrative portion is configured to perform a method, the method comprising:
tracking user activities at the website;
if a weighted value associated with a user activity has changed based on the tracking,
calculating a market value for the user activity,
calculating a divisor value for a new CASE index,
calculating the new CASE index based upon the market value and the divisor,
updating a database to reflect the new CASE index, and
transmitting the new CASE index to the subscription portion.

16. A system in accordance with claim 15, wherein said publication portion includes a publishing application programming interface (API) in communication with engagement endpoints related to the CASE index of a particular website.

17. A system in accordance with claim 16, further comprising a complex event processing engine in communication with said API and an engagements database.

18. A system in accordance with claim 15, wherein said administration portion includes an administration API configured to allow administrative control of calculations related to a CASE index for a website.

19. A system in accordance with claim 15, wherein said subscription portion includes a subscription API configured to facilitate relay of information from subscribers to a CASE index cache cluster.
